(19) United States
(12) Patent Application Publication
(10) Pub. No.: US 2026/0129069 A1
(43) Pub. Date: May 7, 2026

(54) LARGE-SCALE EXCHANGE OF CYBER THREAT INTELLIGENCE VIA ROUTING PROTOCOLS

(71) Applicant: Cisco Technology, Inc., San Jose, CA (US)

(72) Inventor: Omar Santos, Raleigh, NC (US)

(21) Appl. No.: 18/937,900

(22) Filed: Nov. 5, 2024

(51) Int. Cl. H04L 9/40

(52) U.S. Cl. CPC H04L 63/1441

(57) ABSTRACT

The techniques described herein provide a transport mechanism for large-scale exchange of cyber threat intelligence between entities and/or within an entity. Cyber threats evolve rapidly, and entities face challenges in efficiently sharing threat intelligence at “network speed” and applying mitigations across their networks. Existing techniques lack scalability, real-time updates, and coordination among organizations. Moreover, there is no existing technique for large-scale exchange of cyber threat intelligence. Additionally identifying threat data is often performed manually and is subjective. The techniques described herein provide mechanisms that leverage BGP or other routing protocols to facilitate large-scale threat intelligence exchange and mitigation across entities in real-time. The techniques described herein enable entities, including cloud providers, internet service providers, and others, to collaboratively mitigate cyber threats by disseminating real-time confirmed and actionable threat intelligence across their networks.

### TECHNICAL FIELD

The present disclosure relates generally to the field of computer networking, and more particularly to utilizing a routing protocol as a transport mechanism for large-scale exchange of cyber threat information in real-time and across entities.

### BACKGROUND

Networks such as service networks, enterprise networks, cloud providers, etc. often face cyber threats and may utilize threat intelligence feeds to identify threat data, such as indicators of behaviors (e.g., such as indicators of compromise (IoCs), indicators of attack, etc.) indicating a security threat. Current distribution mechanisms for indicators of behavior generally utilize a transport protocol (e.g., trusted automated exchange of intelligence information (TAXII)) to distribute a PDF that points to a potential threat source and is limited to small-scale distributions.

However, cyber threats continue to evolve rapidly, and service providers and other entities face challenges in efficiently sharing threat intelligence at “network speed” and applying mitigating action across their networks. Thus, when a large-scale cyber threat (e.g., such as a global security incident) existing distribution mechanisms for threat intelligence information lack scalability, real-time updates, and coordination among entities, resulting in increased time and duration of the cyber threat before mitigation can occur at a large scale.

Accordingly, there is a need for an authoritative and centralized way to provide large-scale exchange of threat intelligence in real-time within and across entities.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can provide a large-scale exchange of cyber threat intelligence in real-time.

FIG. 2 illustrates a component diagram of an example network controller described in FIG. 1.

FIGS. 3A and 3B illustrate example embodiments of disseminating threat data according to the system described in FIGS. 1 and 2.

FIG. 4 illustrates an example embodiment of disseminating threat data according to the system described the system described in FIGS. 1-3.

FIG. 5 illustrates a flow diagram for distributing threat intelligence via a routing protocol, according to the techniques described in FIGS. 1-4.

FIG. 6 illustrates a flow diagram for performing categorization associated with a routing protocol according to the techniques described in FIGS. 1-5.

FIG. 7 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of computer networking, and more particularly to providing a transport mechanism to enable large-scale exchange of cyber threat intelligence within and across entities in real-time.

A method to perform the techniques described herein may include receiving, from one or more sources, threat intelligence information. Additionally, the method may include determining, based on the threat intelligence information, threat data indicating a cyber threat or a security risk. The method may include generating a message using a routing protocol that includes the threat data as an extension of the routing protocol. Further, the method may include sending the message to one or more routers to enable the one or more routers to perform an action based on the threat data.

Additionally, any techniques described herein may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Cellular networks, Enterprise Networks that are built for a large organization, Internet Threat and compliance data provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches may allow devices in a network to communicate with each other. Routers connect multiple networks, and also connect computers on those networks to the Internet, by acting as dispatchers in networks by analyzing data being sent across a network and choosing an optimal route for the data to travel. Access points act like amplifiers for a network and serve to extend the bandwidth provided by routers so that the network can support many devices located further distances from each other.

Networks such as service networks, enterprise networks, cloud providers, etc. often face cyber threats and may utilize threat intelligence feeds to identify indicators of behaviors (IoCs) indicating a security threat. Current distribution mechanisms for IoCs and other threat data utilize a transport protocol (e.g., trusted automated exchange of intelligence information (TAXII)) to distribute a PDF that points to a potential threat source and is limited to small-scale distributions.

However, cyber threats continue to evolve rapidly, and service providers and other entities face challenges in efficiently sharing threat intelligence at “network speed” and applying mitigating action across their networks. Thus, when a large-scale cyber threat (e.g., such as a global security incident) existing distribution mechanisms for threat intelligence information lack scalability, real-time updates, and coordination among entities, resulting in increased time and duration of the cyber threat before mitigation can occur at a large scale. Moreover, in this scenario, there is no centralized entity that can distribute the threat information across entities in a way that (1) is secure and (2) can be implemented across the infrastructures of the entities.

Accordingly, there is a need for an authoritative and centralized way to provide large-scale exchange of threat intelligence in real-time within and across entities.

This disclosure describes techniques and mechanisms for providing a transport mechanism to enable large-scale exchange of cyber threat intelligence within and across entities in real-time. In some examples, the system may receive, from one or more sources, threat intelligence information. The system may determine, based on the threat intelligence information, threat data indicating a cyber threat or a security risk. The system may generate a message using a routing protocol that includes the threat data as an extension of the routing protocol. The system may send the message to one or more routers to enable the one or more routers to perform an action based on the threat data.

In some examples, the system may comprise a routing protocol component. The routing protocol component may be included as part of a controller, a firewall service of a network device, or any other component of the system. The routing protocol component may be configured to define categories for threat data (e.g., disinformation campaigns, deepfakes, indicators of behaviors (such as indicators of compromise (IoCs), such as data or metadata that indicates a system may be infiltrated or impacted by a cyber threat, indicators of attack, etc.) indicating a security threat. In some examples, IoCs may include, but are not limited to abnormal outbound network traffic, anomalies in privileged user account activity, geographic irregularities (e.g., login attempts from location(s) not associated with an entity or user), swells in database read volume, abnormal number of login attempts, HTML response sizes (e.g., much larger than normal), increased number of requests for a particular file, mismatched port-application traffic, suspicious registry or system file changes, DNS request anomalies, etc. The categories may include malware, phishing, DDoS sources, disinformation, etc. The routing protocol component may assign unique value(s) to each category based on the routing protocol used. For instance, where BGP is implemented, the unique values may correspond to community values associated with a community tag. The routing protocol component may associate the unique values with specific updates of the routing protocol, indicating the type and severity of the threat represented by a particular route for the update.

The routing protocol component may be configured to receive the threat intelligence information from the feed(s) and generate a routing protocol message in response to identifying threat data (e.g., one or more IoCs, indicators of attack, etc.). For example, where BGP is used, the routing protocol message may inject the threat data (e.g., as the unique value associated with the category) into the BGP message as part of a community tag. In this example, the routing protocol component may determine endpoint(s) (e.g., internal router(s), external router(s)/entity(ies), etc.) to send the routing protocol message to the endpoint(s) based on established agreements between entities. For instance, the entities may establish agreement(s) to ensure that threat data received via the routing protocol is from a trusted source, thereby safeguarding against malicious data injection. The routing protocol component may send the routing protocol message to the endpoint(s) via the particular routing protocol (e.g., BGP). In some examples, the routing protocol component may perform one or more actions automatically and/or in response to input from a user (e.g., such as a network administrator).

In some examples, the system may enable the endpoint(s) receiving the routing protocol message to implement filtering policy(ies) based on the community values, allowing for automated, large-scale threat mitigation. In some examples, the system may continuously update the threat intelligence feed and monitor the effectiveness of the threat intelligence exchange for fine-tuning and optimization. In some examples, the system may utilize machine learning models to perform one or more actions described herein. For instance, the routing control component may utilize machine learning models in identifying threat data associated with a particular environment.

In some examples, the system may utilize existing BGP infrastructure to create a network for sharing threat intelligence about deep-fakes and disinformation across organizations and networks. These feeds could contain information about known deep-fake sources, disinformation campaigns, or compromised domains. The speed of BGP (or any other routing protocol) updates would allow for near real-time distribution of new threat intelligence, enabling quick defensive actions against emerging deep-fake or disinformation threats.

Thus, the system may leverage BGP, or other routing protocols or network overlays, to facilitate large-scale threat intelligence exchange and potential mitigating actions in real-time. By utilizing routing protocols, such as BGP, which was originally designed for routing, in a new way, and for a new purpose, the system enables entities to utilize existing infrastructure to disseminate specific threat information that is curated from a reputable source and can be used to combat key large-scale attacks.

In this way, the system may enable entities, including cloud providers, service providers, internet service providers, governmental entities, and others, to collaboratively mitigate cyber threats by disseminating real-time confirmed and actionable threat intelligence across their networks and between entities. Accordingly, the system may provide a highly effective way to quickly identify and mitigate large-scale security incidents (e.g., such as global security incidents), as well as local security incidents (e.g., such as incidents limited to a particular entity.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

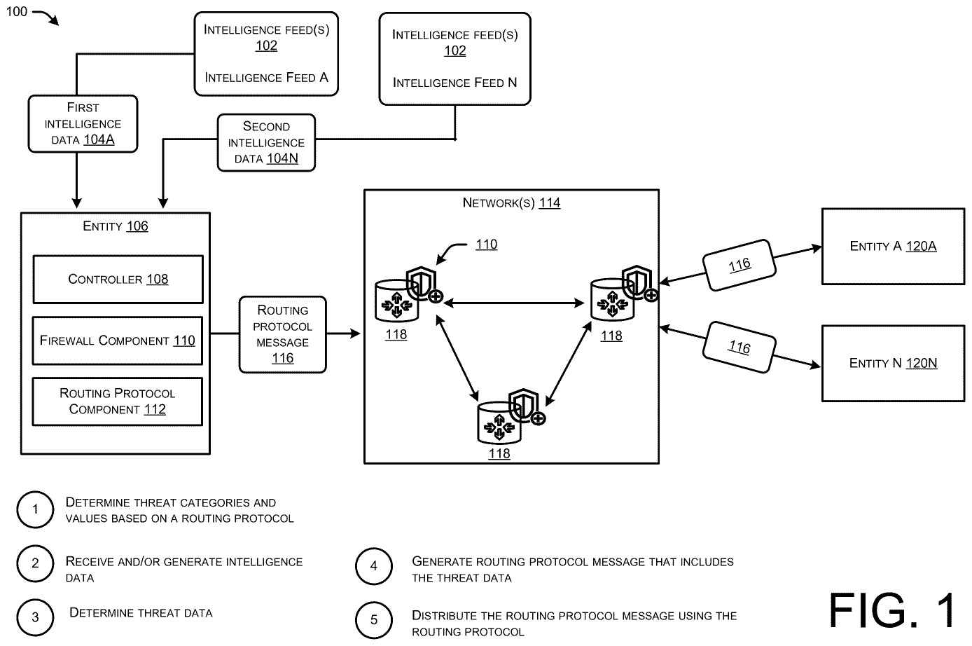

FIG. 1 illustrates a system-architecture diagram of an environment in which a system 100 can provide a large-scale exchange of cyber threat intelligence in real-time. It is understood that any of the components of the system may be implemented on any device in the network(s) 114.

In some examples, the system 100 may include intelligence feed(s) 102. Intelligence feed(s) 102 may comprise intelligence data 104 that is sent to entity 106. In some examples, the intelligence feed(s) 102 be associated with one or more of industry peers, open-source intelligence, government advisories, internet security provider(s), internal threat intelligence service(s) (e.g., such as Cisco's TALOS service), third-party services, etc. In some examples, the intelligence feed(s) 102 may provide real-time streams of the intelligence data 104. In some examples, the intelligence data 104 may comprise data related to current or ongoing cyberthreats. In some examples, the intelligence data 104 may comprise one or more areas of interest (e.g., IP addresses, domains, malware signatures, etc.). For instance, intelligence feed A may send first intelligence data 104A that comprises data including IP addresses related to current or ongoing cyberthreats. Intelligence feed N may send second intelligence data 104N, which may comprise malware signature(s) related to current or ongoing cyberthreats.

The entity 106 may receive the stream(s) of intelligence data 104. The entity 106 may correspond to a service provider (e.g., such as an organization, Cisco, internet service provider (e.g., AT&T, Comcast, etc.), cloud service provider (e.g., Google Cloud, Amazon Web Services, Azure, etc.), an enterprise (e.g., healthcare enterprises, financial enterprises (banks, e-commerce, etc.), etc.), a governmental entity (e.g., such as a government or defense organization), or any other entity that manages security or may utilize the techniques described herein. In some examples, the entity 106 may manage extensive network infrastructures and may be responsible for safeguarding large volumes of sensitive data against cyber threats.

In some examples, the entity 106 may comprise one or more of a controller 108, a firewall component 110, and/or a routing protocol component 112. In some examples, the routing protocol component 112 may be implemented as part of the controller 108 or the firewall component 110. For instance, where the entity 106 corresponds to a cloud service provider, the entity 106 may comprise a controller 108. The controller 108 may be configured to receive the intelligence data 104 from the intelligence feed(s) 102 and determine threat data (e.g., an active cyberthreat attack or potential cyberthreat (such as malware, phishing, etc.), disinformation (such as a deep fake video, disinformation campaign, etc.), or any other potential threat related to an entity, users, or across entities). The threat data may be provided to the routing protocol component 112 to generate a routing protocol message 116 that includes the threat data. The controller 108 and/or routing protocol component 112 may send the routing protocol message 116 to network device(s) 118 within a service network to enable firewall(s) (e.g., firewall component 110) on the network device(s) 118 to perform a mitigating action (e.g., such as blocking an IP address associated with the threat data, etc.). In some examples, the controller 108 and/or routing protocol component 112 may send the routing protocol message 116 through network device(s) 118 and to additional entity(ies) (e.g., such as Entity A 120A and/or Entity N 120N), thereby enabling the additional entity(ies) to perform a mitigating action (e.g., such as blocking an IP address associated with the threat data, etc.).

The routing protocol component may be included as part of the controller 108, a firewall component 110 of the entity 106 and/or network device(s) 118, or any other component of the system. The routing protocol component may be configured to define categories for threat data (e.g., indicators of compromise (IoCs), indicators of attack, disinformation campaign, deepfake, etc.). The categories may include malware, phishing, DDoS sources, disinformation, etc. The routing protocol component 112 may assign unique value(s) to each category based on the routing protocol used. For instance, where BGP is implemented, the unique values may correspond to community values associated with a community tag. The routing protocol component 112 may associate the unique values with specific updates of the routing protocol, indicating the type and severity of the threat represented by a particular route for the update.

Where the routing protocol component 112 is implemented as part of the controller 108, the routing protocol component may be configured to receive the threat data and generate a routing protocol message based on the threat data and the routing protocol associated with the entity 106 and/or additional entity(ies). For example, where BGP is used, the routing protocol message may inject the threat data (e.g., as the unique value associated with the category) into the BGP message as part of a community tag. In this example, the routing protocol component may determine endpoint(s) (e.g., internal router(s), external router(s)/entity(ies), etc.) to send the routing protocol message to the endpoint(s) based on established agreements between entities. For instance, the entities may establish agreement(s) to ensure that threat data received via the routing protocol is from a trusted source, thereby safeguarding against malicious data injection. The routing protocol component may send the routing protocol message to the endpoint(s) via the particular routing protocol (e.g., BGP). In some examples, the routing protocol component may perform one or more actions automatically and/or in response to input from a user (e.g., such as a network administrator).

In some examples, the firewall component 110 may be configured to perform one or more of the actions described above with regard to controller 108 and may be used by the entity 106 in place of the controller 108, such that a separate controller may not be needed to perform the techniques described herein. For instance, the firewall component 110 may be implemented as a firewall service at a network device 118 of the entity and may comprise the routing protocol component 112, such that the firewall component 110 may be configured to perform firewall services, as well as the routing protocol service. Moreover, where the routing protocol component 112 is implemented as part of firewall component 110, the routing protocol component 112 may be configured to receive the threat data intelligence information from the feed(s) and generate a routing protocol message in response to identifying threat data from the intelligence data. The firewall component 110 may be configured to distribute and/or receive the routing protocol message 116 to network device(s) 118 of a network 114. As described above, the network device(s) 118 may include firewall component 110, which may perform firewall service(s) on the network device(s). For instance, the firewall component may be configured to perform mitigating action(s) in response to receiving the routing protocol message 116.

In some examples, the system 100 may include a network 114 that includes network device(s) 118. The network(s) 114 may include one or more networks implemented by any viable communication technology, such as wired and/or wireless modalities and/or technologies. The network(s) 114 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), RA VPNs, VPNs, ZTNA, Wide Area Networks (WANs)—both centralized and/or distributed—and/or any combination, permutation, and/or aggregation thereof. The network(s) 114 may include devices, virtual resources, or other nodes that relay packets from one network segment to another by nodes in the computer network. The network(s) 114 may include multiple devices that utilize the network layer (and/or session layer, transport layer, etc.) in the OSI model for packet forwarding, and/or other layers.

The network device(s) 118 may comprise routers, switches, access points, stations, radios, and/or any other network device. In some examples, the network device(s) 118 may comprise the routing protocol component 112 and/or the firewall component 110.

At “1”, the system may determine threat categories and values based on a routing protocol. For instance, the routing protocol may be indicated in agreements formed between entities. The routing protocol may be based on the protocol utilized by the entity 106. In some examples, the routing protocol may correspond to BGP, however other protocol(s) or network overlays may be used. As noted above, the system may assign unique values to each threat category and may associate the unique value(s) with specific updates of the routing protocol. The specific update(s) may include information or metadata indicating the type of threat and a severity represented by the threat to the entity and/or additional entities.

At “2”, the system may receive and/or generate intelligence data. For instance, the system may receive first intelligence data from an external intelligence feed. The system may additionally generate second intelligence data using an internal service (e.g., such as Cisco's TALOS).

At “3”, the system may determine threat data. For instance, the threat data may be determined based on the intelligence data, the categories, and the values. In some examples, the system may utilize machine learning in order to identify threat data (e.g., such as an IoC, disinformation, etc.).

At “4”, the system may generate a routing protocol message that includes the threat data. For instance, where the routing protocol is BGP, the system may generate a BGP message that includes the threat data (e.g., unique value, type of threat, severity of threat, etc.) as part of a community tag. The type of BGP message generated may correspond to the particular BGP update associated with the unique value.

At “5”, the system may distribute the routing protocol message using the routing protocol. For instance, the system may distribute the routing protocol message as a BGP update. In some examples, the system may distribute the routing protocol message internally. For instance, the system may distribute the BGP update to routers within a service network of the entity to enable the routers to perform a mitigating action. In some examples, the system may distribute the BGP update to external entities, such as a government agency, industry peer(s), etc. Accordingly, where the threat data is specific to a particular entity, the system may protect users internally and where the threat data targets an industry or is across industries, the system may distribute the BGP update to those entities as well.

In this way, the system may enable entities, including cloud providers, service providers, internet service providers, governmental entities, and others, to collaboratively mitigate cyber threats by disseminating real-time confirmed and actionable threat intelligence across their networks and between entities. Accordingly, the system may provide a highly effective way to quickly identify and mitigate large-scale security incidents (e.g., such as global security incidents), as well as local security incidents (e.g., such as incidents limited to a particular entity.

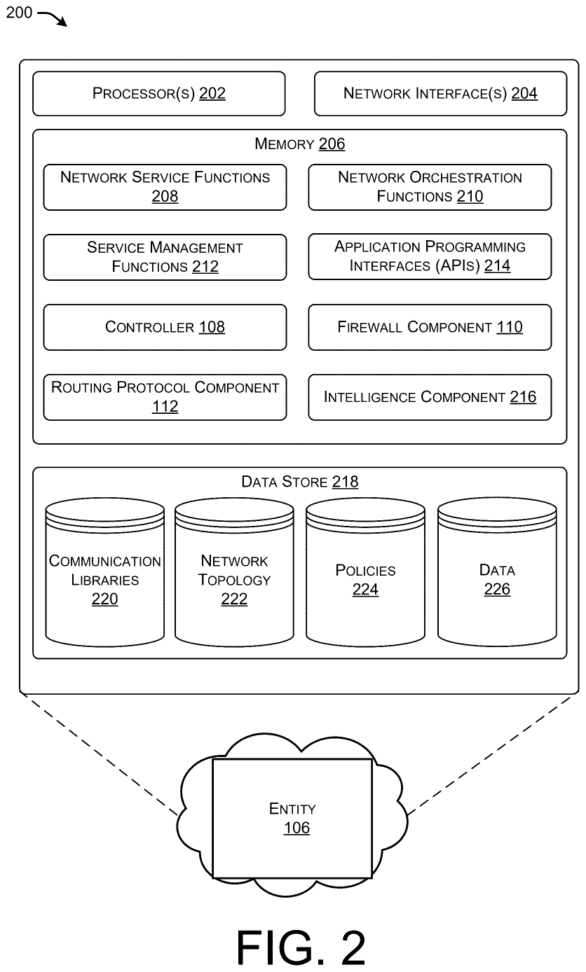

FIG. 2 illustrates a component diagram 200 of an example entity 106, as described in FIG. 1. In some instances, one or more of the components of the entity 106 may run on and/or include one or more computing devices in, or associated with, the service network(s) 114 (e.g., a single device or a system of devices, such as a controller 108, network device(s) 118, etc.). Generally, the entity 106 may include a programmable controller that manages some or all of the controller activities of the service network(s) 114 and manages or monitors the network state using one or more centralized control models.

As illustrated, the entity 106 may include, or run on, one or more hardware processors 202 (processors), one or more devices, configured to execute one or more stored instructions. The processor(s) 202 may comprise one or more cores. Further, the controller 108 may include or be associated with (e.g., communicatively coupled to) one or more network interfaces 204 configured to provide communications with network device(s), the edge device(s), and other devices, and/or other systems or devices in the service network(s) 114 and/or remote from the service network(s) 114. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The entity 106 may also include memory 206, such as computer-readable media, that stores various executable components (e.g., software-based components, firmware-based components, etc.). The memory 206 may generally store components to implement functionality described herein as being performed by the controller 108. The memory 206 may store one or more network service functions 208, such as a slicing manager, a topology manager to manage a topology of the service network(s) 114, a host tracker to track what network components are hosting which programs or software, a switch manager to manage switches of the service network(s) 114, a process manager, and/or any other type of function performed by the controller 108.

The entity 106 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the service network(s) 114 (configurable), and one or more APIs 214 for communicating with devices in the service network(s) 114 and causing various controller functions to occur.

In some examples, the entity 106 may include one or more of a controller 108, a firewall component 110, a routing protocol component 112, and/or an intelligence component 216. In some examples, the entity 106 may include additional or fewer components. The firewall component 110 and controller 108 may be configured to perform actions described above with regard to FIG. 1.

The routing protocol component 112 may be included as part of the controller 108, the firewall component 110, etc. The routing protocol component may be configured to define categories for threat data (e.g., indicators of compromise (IoCs), indicators of attack, disinformation campaign, deepfake, etc.). The categories may include malware, phishing, DDoS sources, disinformation, etc. The routing protocol component may assign unique value(s) to each category based on the routing protocol used. For instance, where BGP is implemented, the unique values may correspond to community values associated with a community tag. The routing protocol component may associate the unique values with specific updates of the routing protocol, indicating the type and severity of the threat represented by a particular route for the update, and store the association in memory of or associated with the entity 106.

The routing protocol component 112 may be configured to receive the threat intelligence information from the feed(s) and generate a routing protocol message in response to identifying the threat data. For example, where BGP is used, the routing protocol message may inject the threat data (e.g., as the unique value associated with the category) into the BGP message as part of a community tag. In this example, the routing protocol component may determine endpoint(s) (e.g., internal router(s), external router(s)/entity(ies), etc.) to send the routing protocol message to the endpoint(s) based on established agreements between entities. In some examples, the routing protocol message may be encrypted, cryptographically signed, hashed, or utilize any other security technique to ensure that the threat information has not been manipulated.

For instance, the entities may establish agreement(s) to ensure that threat data received via the routing protocol is from a trusted source, thereby safeguarding against malicious data injection. The routing protocol component may send the routing protocol message to the endpoint(s) via the particular routing protocol (e.g., BGP). In some examples, the routing protocol component may perform one or more actions automatically and/or in response to input from a user (e.g., such as a network administrator).

The intelligence component 216 may be configured to support one or more of the controller 108, firewall component 110, and/or routing protocol component 112. For instance, the intelligence component 216 may be configured to generate, train, update, and store one or more machine learning models. For instance, the intelligence component 216 may be configured to receive the intelligence data as input and, based on the intelligence data, identify the threat data as it relates to one or more particular environments associated with the entity and/or additional entities. In some examples, the intelligence component 216 may comprise models trained to identify disinformation and/or deep fake artificial intelligence associated with one or more of the intelligence feeds and/or to notify service providers or other entities. For instance, the models may be trained based on one or more of previous threat data utilized by the entity or other entities, open-sourced threat data, feedback received from a network administrator of the entity 106 indicating whether data is a threat or not, deepfake information, etc. In some examples, the intelligence component 216 may receive the intelligence data as input and may output indications of threat data associated with potential threats, as well as a risk score associated with how severe the threat is. The intelligence component 216 may send this information to the routing protocol component 112 for comparison against a threshold score. In contrast to existing techniques for selecting and identifying threat data associated with a particular environment, which are performed manually and are subjective, resulting in threats being missed, and are difficult to implement at a large scale, the techniques described herein may provide an automatic way to analyze a large amount of threat intelligence information and identify specific risks associated with an environment of the entity.

In some examples, the intelligence component 216 may comprise one or more pre-trained models and/or pre-trained weighted models. In some examples, the artificial intelligence models are pre-trained using machine learning techniques. In some examples, the entity 106 and/or intelligence component 216 may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the intelligence component 216 may update the application models based on real-time intelligence data or threat data received from the intelligence feeds and/or other entities. The intelligence component 216 may be configured to update the one or more machine learning models based on feedback received from network device(s) 118, other entities 120, outputs from the machine learning models, and/or a network administrator.

The entity 106 may further include a data store 218, such as long-term storage, that stores communication libraries 220 for the different communication protocols that the entity 106 is configured to use or perform. Additionally, the data store 218 may include network topology data 222, such as a model representing the layout of the network components in the service network(s) 114 and/or data indicating available bandwidth, available CPU, delay between nodes, computing capacity, processor architecture, processor type(s), etc. The data store 218 may store policies 224 that include, but are not limited to, network policy(ies), network controller policy(ies), security data associated with the network, security policies configured for the network, agreement(s) and/or policies between entities, firewall policies, firewall configuration data, network configuration policies, network configuration data, security posture data, organization and/or entity policies, filtering policies, and/or compliance policies configured for the network. The data store 218 may store data 226 including metadata, threat data, threat intelligence information, category data, unique value data, severity data, routing protocol data, threat type data, risk score data, threshold score data, performance data, traffic data, flow logs, instruction data, location data, telemetry data, or any other data, metadata, and/or information described herein.

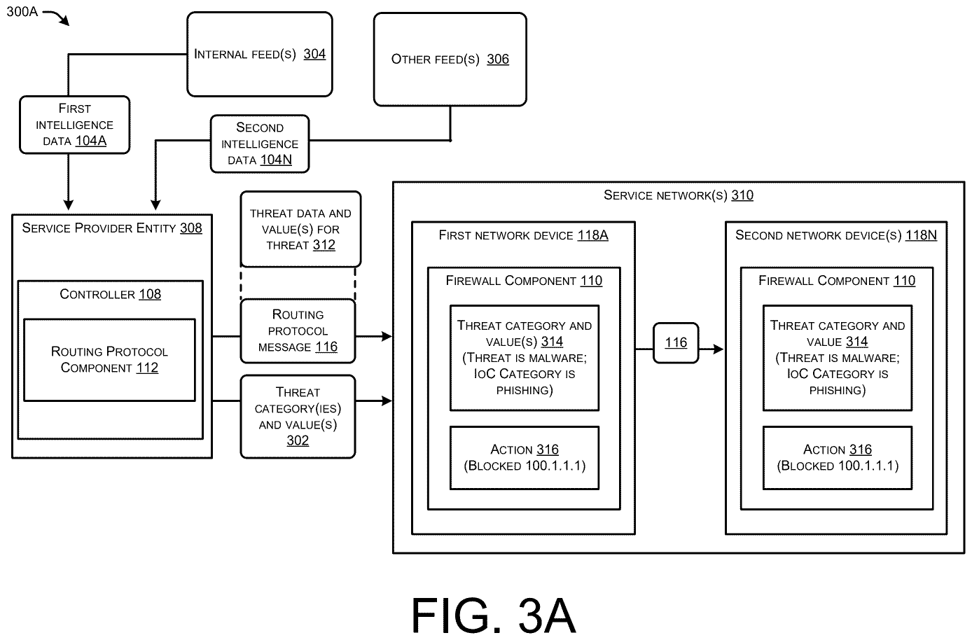

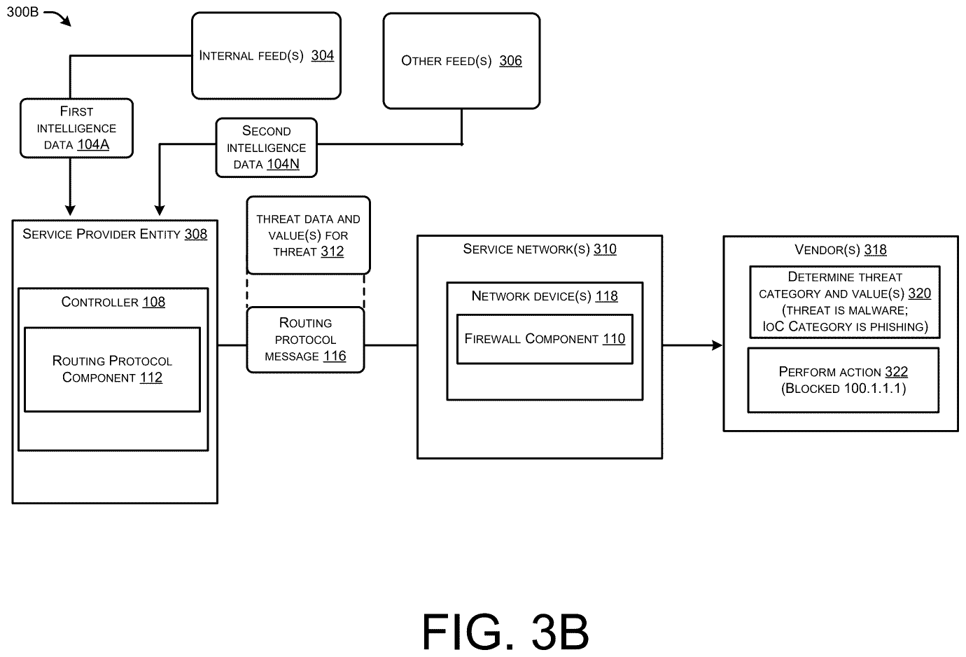

FIGS. 3A and 3B illustrate example embodiments of distributing threat data according to the techniques described in FIGS. 1 and 2. FIG. 3A illustrates a first embodiment 300A that corresponds to distribution of the routing protocol message 116 to an internal network of a service provider. For instance, the first embodiment 300A may correspond to an example where the routing protocol message 116 is pushed to an internal network of the service provider entity 308. While the first embodiment 300A illustrates the use of a controller 108, as noted above, the functions may be performed by firewall component 110 and/or routing protocol component 112, such as where a controller is not needed. In some examples, the service provider entity 308 of FIG. 3A may correspond to a service provider (e.g., such as Cisco), an internet service provider, or any other cloud-based or cellular-based service entity.

As illustrated in FIG. 3A, the first embodiment 300A includes first intelligence data 104A, second intelligence data 104N, controller 108, routing protocol component 112, network device(s) 118A, 118N, firewall component 110, and routing protocol message 116.

The service provider entity 308 may be configured to receive the first intelligence data 104A from internal feed(s) 304. Internal feed(s) 304 may correspond to one or more threat intelligence feeds owned, managed, or associated with services provided by the service provider entity 308. For instance, where the service provider entity 308 is Cisco, the first intelligence data 104A may be received from a service such as Cisco's TALOS. Thus, as noted above, the service provider entity 308 may generate the intelligence data and/or threat data. The service provider entity 308 may receive the second intelligence data 104N from other feed(s) 306. For instance, the other feed(s) 306 may correspond to one or more external intelligence feed(s) (e.g., such as open-sourced intelligence feed(s), third-party feed(s), etc.).

The first embodiment 300A further illustrates the service provider entity 308 sending threat category(ies) and value(s) 302 to the service network(s) 310. The threat category(ies) and value(s) 302 may comprise the categorization(s) associated with threat data, values associated with routing protocol(s), and any other information noted above and/or agreed upon between entities. Service network(s) 310 may comprise the service network of the service provider entity 308. The first network device 118A may receive and store the threat category(ies) and value(s) 302 in memory and may send the threat category(ies) and value(s) to one or more second network device(s) 118N throughout the service network(s) 310.

As noted above, the controller 108 may receive the first intelligence data 104A and second intelligence data 104N and determine threat data. The controller 108 may generate and push the routing protocol message to the service network(s) 310. As illustrated and described above, the routing protocol message 116 may comprise a protocol route with threat data and value(s) for malware 312. For instance, the protocol route may correspond to a route through the service network 310 that is associated with a particular update that the routing protocol is sent along. The value(s) may indicate the type and the severity of a particular threat. The protocol route with threat data and value(s) for malware 312 may correspond to a BGP route that includes the threat data as a community tag extension, where the threat data includes the value(s) and the value(s) indicate that the threat is malware.

As illustrated in FIG. 3A, a first network device 118A may receive the routing protocol message 116. At 314, the firewall component 110 of the first network device 118A may determine a threat category and value associated with and/or indicated by the routing protocol message 116. In the illustrated example, the firewall component 110 determines that the IoC category is phishing. At 316, the firewall component 110 may perform an action 316. As illustrated, the action 316 may include blocking an IP address (e.g., 100.1.1.1) of the malware, where the IP address is included as part of the threat data. The first network device 118A may send the routing protocol message 116 to one or more second network device(s) 118N within the service network 310. The second network device(s) 118N may perform similar action(s) described with regard to the first network device 118A in response to receiving the routing protocol message 116. In some examples, the second network device(s) 118N may perform the action(s) in parallel or near real-time with the first network device 118A.

In this way, the system may utilize existing routing protocol infrastructure (e.g., such as BGP) to disseminate threat data throughout an internal service network and enable network device(s) 118 to perform mitigating action(s) (e.g., blocking, etc.) in near real-time. Thus, a service provider entity may

FIG. 3B illustrates a second embodiment 300B that corresponds to the service provider entity 308 distributing the routing protocol message 116 to vendor(s) 318 (e.g., other entities). In some examples, the communications shown in FIG. 3B may be used in conjunction with the communications illustrated in FIG. 3A. For instance, the second embodiment 300B may correspond to an example where the routing protocol message 116 is sent through the network device(s) 118 of the service network(s) 310, allowing the internal network to perform a mitigating action, and sent to the vendor(s) 318 to allow the vendor(s) 318 to also perform mitigating action(s). In some examples, the second embodiment 300B may correspond to an example where the routing protocol message 116 is sent through the service network(s) 310 to vendor(s) 318, to enable the vendor(s) 318 to perform mitigating action(s).

While the second embodiment 300B illustrates the use of controller 108, it is understood that the service provider entity 308 may not utilize a separate controller and may use firewall component 110 and/or routing protocol component to perform the actions described herein.

As illustrated in FIG. 3B, the second embodiment 300B includes first intelligence data 104A, second intelligence data 104N, controller 108, routing protocol component 112, network device(s) 118A, 118N, firewall component 110, routing protocol message 116, internal feed(s) 304, other feed(s) 306, protocol route with threat data and value(s) for malware 312, and service network(s) 310. Additionally, the second embodiment may include vendor(s) 318, which may correspond to one or more other entities (e.g., industry peers, service providers, internet service providers, etc.). The vendor(s) 318 may comprise entities that have formed agreement(s) with the service provider entity 308, as described herein.

As illustrated and described in FIG. 3A, the service provider entity 308 may distribute the routing protocol message 116 to the vendor(s) 318 through service network(s) 310. The routing protocol message 116 may be sent as a BGP message and/or BGP update (according to previously established agreements) that includes the threat data as a community tag extension. As noted above, the routing protocol message may be encrypted using encryption techniques.

The vendor(s) 318 may receive the routing protocol message 116. In response to receiving the routing protocol message 116, the vendors may determine the threat category and value(s) 320 indicated by the message (e.g., such as by decrypting the message, extracting the community tag threat data, etc.) and may perform an action 322. As illustrated, the vendor(s) may determine the category indicates that the threat is phishing and may block IP address 100.1.1. Thus, the techniques enable real-time, curated IoC threat intelligence exchange on a massive scale, addressing the limitations of traditional sharing methods that often rely on manual processes.

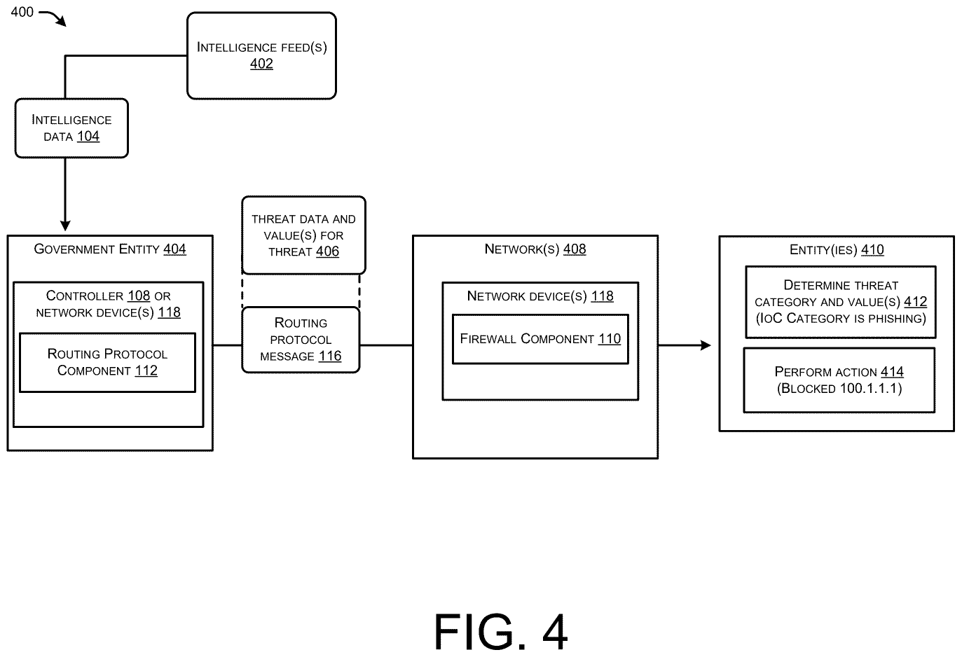

FIG. 4 illustrates an exemplary embodiment 400 of disseminating threat data, according to the system and techniques of FIGS. 1-3. In some examples, the embodiment 400 described in FIG. 4 is associated with a government entity distributing threat data to various entity(ies). As illustrated in FIG. 4, the embodiment 400 includes intelligence data 104, controller 108, network device(s) 118, routing protocol component 112, firewall component 110, and routing protocol message 116.

Embodiment 400 further includes intelligence feed(s) 402. Intelligence feed(s) 402 may comprise any of the intelligence feed(s) 102 described herein. The government entity 404 may comprise an entity associated with threat intelligence, or any other reputable governmental source.

As illustrated, the government entity 404 may distribute the routing protocol message 116 to the entity(ies) 410 through the network(s) 408 (e.g., Internet, service network, etc.). The routing protocol message 116 may be sent via a specific protocol route and may include threat data and value(s) indicating the threat 406. For example, the routing protocol message 116 may be sent as a BGP message and/or BGP update that includes the threat data and value(s) as a community tag extension. As noted above, the routing protocol message 116 and/or portions of the routing protocol message may be encrypted using encryption techniques.

The entity(ies) 410 may receive the routing protocol message 116. In response to receiving the routing protocol message 116, the entity(ies) 410 may determine the threat category and value(s) 412 indicated by the message (e.g., such as by decrypting the message, extracting the community tag threat data, etc.) and may perform an action 414. As illustrated, the entity(ies) 410 may determine the category indicates that the threat is phishing and may block IP address 100.1.1. Thus, the techniques enable real-time, curated IoC threat intelligence exchange on a massive scale, addressing the limitations of traditional sharing methods that often rely on manual processes.

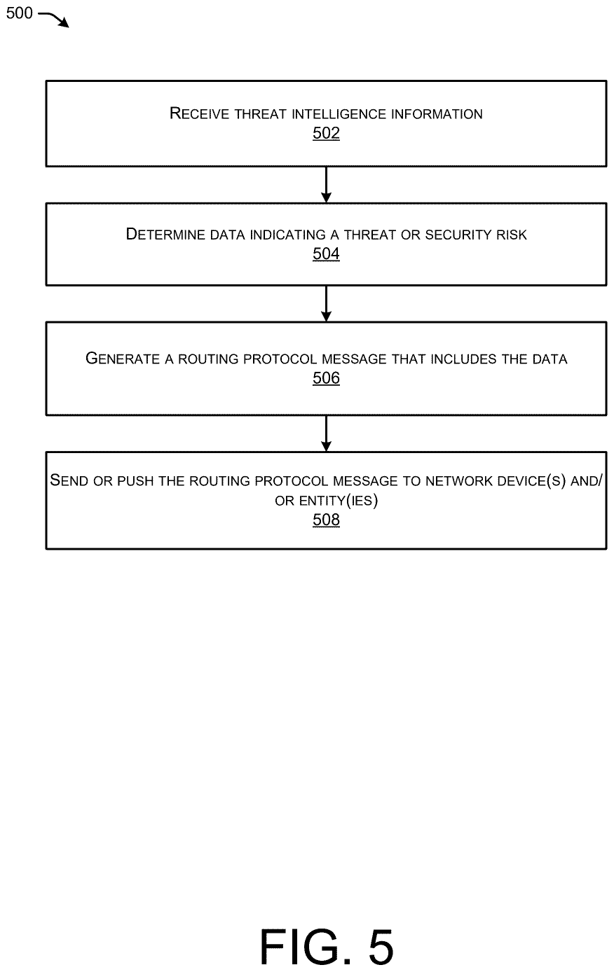

FIG. 5 illustrates a flow diagram of an example system 500 for distributing threat intelligence via a routing protocol, according to the system described in FIGS. 1-4 herein. The system 500 may be performed by one or more devices (e.g., controller 108, firewall component 110, routing protocol component 112, network device 118, etc.) that include one or more processors and one or more non-transitory computer-readable media storing computer-executable instructions that, when executed by the one or more processors, cause the one or more processors to perform operations of system 500.

At 502, the system may receive threat intelligence information. For instance, the system may receive the threat intelligence information from one or more intelligence feeds 102. As noted above, the system may be performed by an entity 106, a controller 108, a firewall (e.g., firewall component 110), etc. In some examples, the entity includes at least one of a service provider, an internet service provider, a vendor, or a government entity. In some examples, the threat intelligence information is received from one or more sources, the one or more sources include at least one of: a third-party entity; an open-source entity; or an internal service of an entity.

At 504, the system may determine data indicating a threat or security risk. The data may comprise threat data, as described herein. In some examples, the system may determine the data automatically or in response to input received from a user of the system. For instance, determining the data automatically may comprise: identifying, using a model, a portion of the threat intelligence information associated with an environment; generating, based on the portion of the threat intelligence information, a score indicating a risk or a threat associated with the portion of the threat intelligence information to the environment; and based on determining the score is above a threshold, generating the message. In some examples, the data is generated by the controller or a service offered by the service provider.

At 506, the system may generate a routing protocol message that includes the data. For instance, where the routing protocol is BGP, generating the message may comprise injecting the threat data into a BGP message as part of a community tag extension.

In some examples, the system further comprises defining respective categories for each respective indicator of compromise; assigning, based on the routing protocol, unique values to each of the respective categories; associating the unique values with one or more updates associated with the routing protocol; and storing the associations in a memory, wherein generating the message is based at least in part on accessing one or more of the unique values associated with the threat data.

At 508, the system may send or push the routing protocol message to network device(s) and/or entity(ies). For instance, the system may send the routing protocol message to router(s) of a service network and/or router(s) of one or more entities. In some examples, the message is sent from a first entity and the one or more routers are associated with at least one of: an environment of the first entity; one or more second entities associated with the first entity; or one or more users (e.g., such as customers, etc.) associated with the first entity or the one or more second entities.

In this way, the system may enable entities, including cloud providers, service providers, internet service providers, governmental entities, and others, to collaboratively mitigate cyber threats by disseminating real-time confirmed and actionable threat intelligence across their networks and between entities. Accordingly, the system may provide a highly effective way to quickly identify and mitigate large-scale security incidents (e.g., such as at a global security incidents), as well as local security incidents (e.g., such as incidents limited to a particular entity.

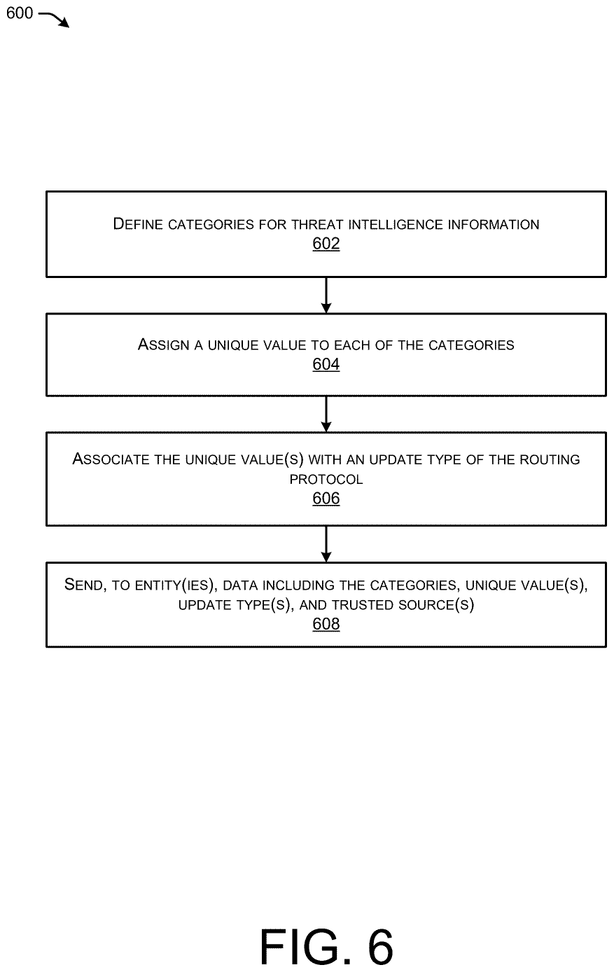

FIG. 6 illustrates a flow diagram of an example system 600 for performing categorization associated with a routing protocol according to the techniques described in FIGS. 1-5. In some instances, one or more of the steps of system 600 may be performed by one or more devices (e.g., controller 108, firewall component 110, routing protocol component 112, network device 118, etc.) that include one or more processors and one or more non-transitory computer-readable media storing computer-executable instructions that, when executed by the one or more processors, cause the one or more processors to perform operations of system 600.

At 602, the system may define categories for threat intelligence information. For instance, the system may define categories for threat data (e.g., disinformation campaigns, deepfakes, indicators of behaviors (such as indicators of compromise (IoCs), such as data or metadata that indicates a system may be infiltrated or impacted by a cyber threat, indicators of attack, etc.) indicating a security threat. In some examples, IoCs may include, but are not limited to abnormal outbound network traffic, anomalies in privileged user account activity, geographic irregularities (e.g., login attempts from location(s) not associated with an entity or user), swells in database read volume, abnormal number of login attempts, HTML response sizes (e.g., much larger than normal), increased number of requests for a particular file, mismatched port-application traffic, suspicious registry or system file changes, DNS request anomalies, etc. The categories may include malware, phishing, DDoS sources, disinformation, etc. The routing protocol component may assign unique value(s) to each category based on the routing protocol used. For instance, where BGP is implemented, the unique values may correspond to community values associated with a community tag. The routing protocol component may associate the unique values with specific updates of the routing protocol, indicating the type and severity of the threat represented by a particular route for the update.

At 604, the system may assign a unique value to each of the categories. In some examples, the unique value(s) may be assigned to each category based on the type of routing protocol used. For instance, where BGP is implemented, the unique values may correspond to community values associated with a community tag.

At 606, the system may associate the unique value(s) with an update type of the routing protocol. For instance, where the routing protocol is BGP, the system may associate the unique values with a specific type of BGP update. The system may also associate or store indications of the type and severity of the threat represented by a particular BGP update route (e.g., as metadata).

At 608, the system may send, to entity(ies), data including the categories, unique value(s), update type(s), and trusted source(s). For instance, the system may push the information to network device(s) of a service provider entity, such that when the network device(s) receive a BGP message, the network device(s) can identify and determine what the threat is, how severe the threat is, action(s) to be performed, etc.

In this way, the system may enable entities, including cloud providers, service providers, internet service providers, governmental entities, and others, to collaboratively mitigate cyber threats by disseminating real-time confirmed and actionable threat intelligence across their networks and between entities. Accordingly, the system may provide a highly effective way to quickly identify and mitigate large-scale security incidents (e.g., such as at a global security incidents), as well as local security incidents (e.g., such as incidents limited to a particular entity.

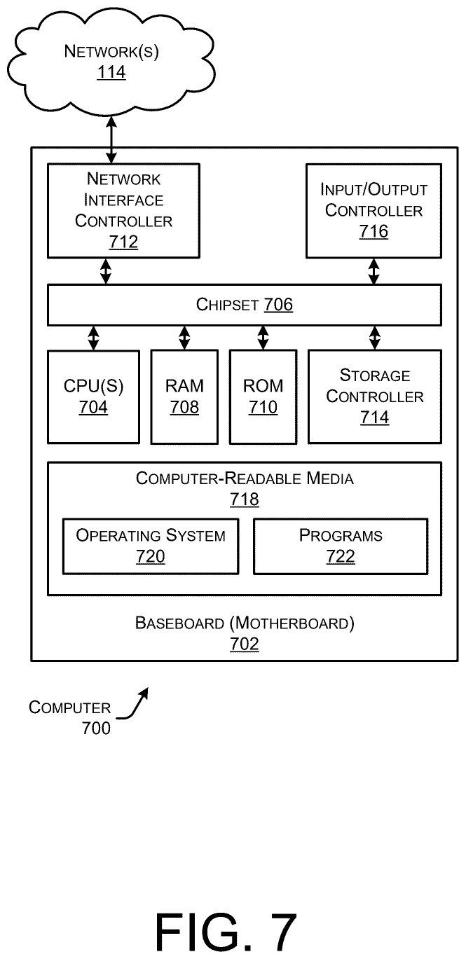

FIG. 7 shows an example computer architecture for a device capable of executing program components for implementing the functionality described above. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein. The computer may, in some examples, correspond to a controller 108, firewall component 110, routing protocol component 112, network device 118, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to start up the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as service network(s) 114. The chipset 706 can include functionality for providing network connectivity through a NIC 712, such as a gigabit Ethernet adapter. The NIC 712 is capable of connecting the computer 700 to other computing devices over the service network(s) 114. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the controller 108, firewall component 110, routing protocol component 112, network device 118, and/or any components included therein, may be supported by one or more devices similar to computer 700. Stated otherwise, some or all of the operations performed by the controller 108, firewall component 110, routing protocol component 112, network device 118, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

As described herein, the computer 700 may comprise one or more of a controller 108, firewall component 110, routing protocol component 112, network device 118, and/or any other device. The computer 700 may include one or more hardware processors (processors) configured to execute one or more stored instructions. The processor(s) may comprise one or more cores. Further, the computer 700 may include one or more network interfaces configured to provide communications between the computer 700 and other devices, such as the communications described herein as being performed by the controller 108 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure. For instance, the programs 722 may cause the computer 700 to perform techniques including receiving, from one or more sources, threat intelligence information; determining, based on the threat intelligence information, threat data indicating a cyber threat or a security risk; generating a message using a routing protocol that includes the threat data as an extension of the routing protocol; and sending the message to one or more routers to enable the one or more routers to perform an action based on the threat data.

In this way, the computer 700 can entities, including cloud providers, service providers, internet service providers, governmental entities, and others, to collaboratively mitigate cyber threats by disseminating real-time confirmed and actionable threat intelligence across their networks and between entities. Accordingly, the computer 700 may provide a highly effective way to quickly identify and mitigate large-scale security incidents (e.g., such as at a global security incidents), as well as local security incidents (e.g., such as incidents limited to a particular entity.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of large-scale exchange of cyber threat intelligence, comprising:
receiving, from one or more sources, threat intelligence information;
determining, based on the threat intelligence information, threat data indicating a cyber threat or a security risk;
generating a message using a routing protocol that includes the threat data as an extension of the routing protocol; and
sending the message to one or more routers to enable the one or more routers to perform an action based on the threat data.

2. The method of claim 1, wherein determining the threat data is performed automatically and comprises:
identifying, using a model, a portion of the threat intelligence information associated with an environment;
generating, based on the portion of the threat intelligence information, a score indicating a risk or a threat associated with the portion of the threat intelligence information to the environment; and
based on determining the score is above a threshold, generating the message.

3. The method of claim 1, wherein the method is performed by one of a firewall or a controller of an entity.

4. The method of claim 3, wherein the entity includes at least one of a service provider, an internet service provider, a vendor, or a government entity.

5. The method of claim 1, further comprising:
defining respective categories for each respective indicator of compromise;
assigning, based on the routing protocol, unique values to each of the respective categories;
associating the unique values with one or more updates associated with the routing protocol; and
storing the associations in a memory,
wherein generating the message is based at least in part on accessing one or more of the unique values associated with the threat data.

6. The method of claim 1, wherein the method is implemented by a controller of a service provider and the threat data is generated by the controller or a service offered by the service provider.

7. The method of claim 1, wherein the one or more sources include at least one of:
a third-party entity;
an open-source entity; or
an internal service of an entity.

8. The method of claim 1, wherein the message is sent from a first entity and the one or more routers are associated with at least one of:
an environment of the first entity;
one or more second entities associated with the first entity; or
one or more users associated with the first entity or the one or more second entities.

9. A system comprising:
one or more processors; and
one or more computer-readable media storing instructions that, when executed by the one or more processors, cause the one or more processors to perform operations comprising:
receiving, from one or more sources, threat intelligence information;
determining, based on the threat intelligence information, threat data indicating a cyber threat or a security risk;
generating a message using a routing protocol that includes the threat data as an extension of the routing protocol; and
sending the message to one or more routers to enable the one or more routers to perform an action based on the threat data.

10. The system of claim 9, wherein determining the threat data is performed automatically and comprises:
identifying, using a model, a portion of the threat intelligence information associated with an environment;
generating, based on the portion of the threat intelligence information, a score indicating a risk or a threat associated with the portion of the threat intelligence information to the environment; and
based on determining the score is above a threshold, generating the message.

11. The system of claim 9, wherein the system is performed by a firewall or a controller of an entity.

12. The system of claim 11, wherein the entity includes at least one of a service provider, an internet service provider, a vendor, or a government entity.

13. The system of claim 9, the operations further comprising:
defining respective categories for each respective indicator of compromise;
assigning, based on the routing protocol, unique values to each of the respective categories;
associating the unique values with one or more updates associated with the routing protocol; and
storing the associations in a memory,
wherein generating the message is based at least in part on accessing one or more of the unique values associated with the threat data.

14. The system of claim 9, wherein the system is performed by a controller of a service provider and the threat data is generated by the controller or a service offered by the service provider.

15. The system of claim 9, wherein the one or more sources include at least one of:
a third-party entity;
an open-source entity; or
an internal service of an entity.

16. The system of claim 9, wherein the message is sent from a first entity and the one or more routers are associated with at least one of:
a service network of the first entity;
one or more second entities associated with the first entity; or
one or more users associated with the first entity or the one or more second entities.

17. One or more non-transitory computer-readable media maintaining instructions that, when executed by one or more processors of a network device or a controller, program the one or more processors to perform operations comprising:
receiving, from one or more sources, threat intelligence information;
determining, based on the threat intelligence information, threat data indicating a cyber threat or a security risk;
generating a message using a routing protocol that includes the threat data as an extension of the routing protocol; and
sending the message to one or more routers to enable the one or more routers to perform an action based on the threat data.

18. The one or more non-transitory computer-readable media of claim 17, the operations further comprising:
defining respective categories for each respective indicator of compromise;
assigning, based on the routing protocol, unique values to each of the respective categories;
associating the unique values with one or more updates associated with the routing protocol; and
storing the associations in a memory.

19. The one or more non-transitory computer-readable media of claim 17, wherein the one or more sources include at least one of:
a third-party entity;
an open-source entity; or
an internal service of an entity.

20. The one or more non-transitory computer-readable media of claim 17, wherein determining the threat data is performed automatically and comprises:
identifying, using a model, a portion of the threat intelligence information associated with an environment;
generating, based on the portion of the threat intelligence information, a score indicating a risk or a threat associated with the portion of the threat intelligence information to the environment; and
based on determining the score is above a threshold, generating the message.
